(19) United States
(12) Patent Application Publication
(10) Pub. No.: US 2010/0170072 A1
(43) Pub. Date: Jul. 8, 2010

(54) Universal sprinkler nozzle tool

(76) Inventor: Jay Price Elzey, Phoenix, AZ (US)

Correspondence Address: RUTH EURE, 4795 EDISON AVENUE, BOULDER, CO, 80301, US

(21) Appl. No.: 12/592,231

(22) Filed: Nov. 20, 2009

Related U.S. Application Data
(60) Provisional application No. 61/204,438, filed on Jan. 7, 2009.

(51) Int. Cl. B25B 27/04

(52) U.S. Cl. 29/278

(57) ABSTRACT

The present invention provides a hand held tool comprising an elongate handle portion having a first end and a second end, terminating at its first end in a bifurcated wedge portion terminating in a pair of spaced apart tines for engagement with the sprinkler nozzle, said tines being essentially orthogonal to the axis of the shaft of the handle portion. When the tines of the bifurcated wedge portion engage with the sprinkler nozzle, the handle can be lifted to raise the nozzle for maintenance.

### CLAIM OF PRIORITY

The present application claims priority under 35 USC 119(e) (1) from U.S. Provisional Application Ser. No. 61/204,438 filed Jan. 7, 2009, of common inventorship and title herewith.

### FIELD OF THE INVENTION

The present invention pertains to the field of sprinkler nozzle tools for use with in ground sprinklers.

### BACKGROUND OF THE INVENTION

The prior art has put forth several tools for handling sprinkler heads. Among these are:

U.S. Pat. No. 6,957,477 to Neiman describes a tool for installing nozzles in pop-up sprinkler heads. This reference includes a pilot pin for insertion into the bottom of the sprinkler head.

U.S. Pat. No. 3,977,063 to Bruinga describes an apparatus and method for removing a sprinkler head from a pop-up sprinkler casing. The tool of this reference comprises a gripping portion and a portion for holding a pop up cover out of engagement with the top of the sprinkler casing.

U.S. Pat. No. 6,152,651 to Glidewell describes an underground sprinkler elevating apparatus and method which comprises a hydraulic actuator and pressurized fluid to drive the actuator to adjust the level of the sprinkler in the ground.

U.S. Pat. No. 6,425,564 to Harnik describes a sprinkler head installation tool comprising an elongated member and a spring loaded holding member.

U.S. Pat. No. 6,487,942 to Carter et al describes a fire sprinkler head tool which comprises modified vice grips.

U.S. Pat. No. 4,788,894 to Mitschele describes a hand tool for removing sprinkler heads from underground watering systems. The tool of this reference is designed for gripping and rotating the sprinkler head.

None of these references describe the present invention.

### SUMMARY OF THE INVENTION

It is an object of the present invention to provide a sprinkler nozzle tool for securely grabbing and lifting recessed and non-recessed sprinkler heads.

It is a further object of the preset invention to provide a sprinkler nozzle tool useful for identifying the location of sprinkler heads.

It is a further object of the present invention to provide a sprinkler nozzle tool, which is useful for a wide variety of makes and models of sprinkler heads.

### BRIEF DESCRIPTION OF THE DRAWING

FIG. 1 is a front perspective view of the sprinkler nozzle tool of the present invention.

FIG. 2 is a front view of the sprinkler nozzle tool of the present invention.

FIG. 3 is a back view of the sprinkler nozzle tool of the present invention.

FIG. 4 is a top perspective view of the sprinkler nozzle tool of the present invention.

FIG. 5 is a side view of the sprinkler nozzle tool of the present invention.

FIG. 6 is a bottom view of the sprinkler nozzle tool of the present invention.

### DETAILED DESCRIPTION OF THE INVENTION

As used herein, the terms “sprinkler head”, “sprinkler nozzle” and “pop up sprinkler head” are interchangeable and intended to mean any of a variety of devices for dispersing water onto a lawn, garden, crop, field or other area where water is desired or required.

The present invention provides a hand held tool comprising an elongate handle portion having a first end and a second end, terminating at its first end in a bifurcated wedge portion terminating in a pair of spaced apart tines for engagement with the sprinkler nozzle, said tines being essentially orthogonal to the axis of the shaft of the handle portion. When the tines of the bifurcated wedge portion engage with the sprinkler nozzle, the handle can be lifted to raise the nozzle for maintenance.

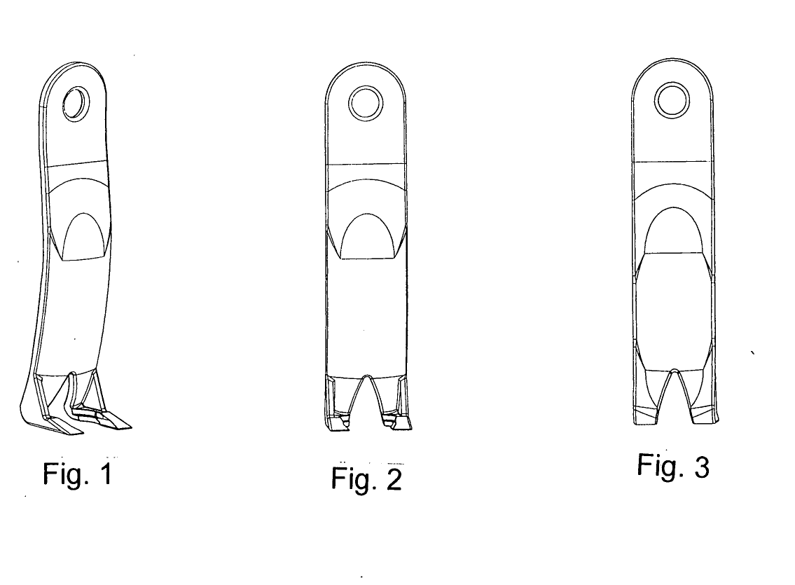

The bifurcated wedge portion terminates in a pair of tapered tines which are essentially parallel and are spaced apart to embrace the flange of a pop up sprinkler head. These features of the tines are clearly seen in FIGS. 1, 5 and 6.

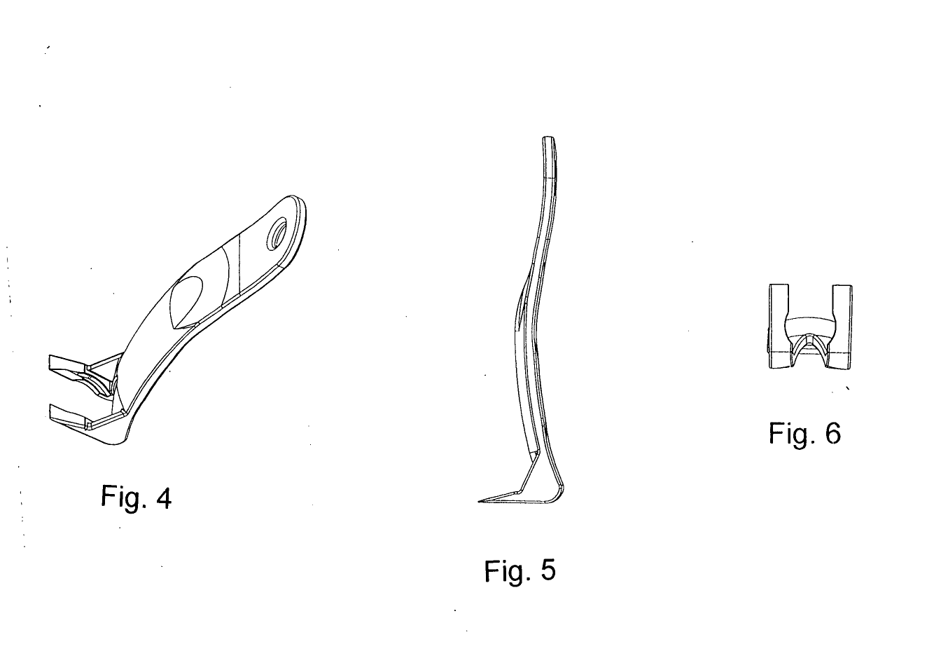

The tapered tines are positioned at essentially a right angle to the axis of the shaft of the elongate handle portion and are buttressed by a triangular support portion to add structural integrity to the device so that pulling up on the elongate handle portion will pull up on the pop up sprinkler head when an upward force is applied to the device. The triangular support is clearly seen in FIGS. 1, 4 and 5. Each tapered tine begins at the base of the triangular support portion at a thickness of about 0.145 inch and tapers to a thickness of about 0.025 inch at its terminus. Each tine is about 0.25 inch in width at its widest dimension. The space between the tines is contoured to securely receive a round sprinkler head. The contoured space is clearly shown in FIG. 6.

The shaft of the elongate handle portion is slightly curved to comfortably receive a human hand with the thumb of the hand of the user engaging the convex portion of the curve of the shaft of the elongate handle portion and to lend structural integrity to the device. This arcuate configuration can be clearly seen in FIGS. 1, 4 and 5. The width of the elongate handle portion is approximately 1 inch to about 1.2 inches. The length of the entire device is approximately 5 inches. The thickness of the device is about 0.125 to about 0.15 inch. The space between the tines at their termini is about 0.63 inch.

The elongate handle portion terminates at its second end in a flattened rounded portion having a hole for receiving a carabineer, keychain or other holding device. This hole is about 0.25 inch to about 0.4 inch in diameter.

The device of the present invention is designed to engage the pop up portion of a sprinkler head by inserting the bifurcated tines under the round flange of the sprinkler head. The device can be used to service the sprinkler head. Alternatively, the device can be used to engage the pop up portion of a sprinkler head and temporarily left in place to identify the location of the sprinkler heads for planning and servicing a landscaping or other area to be equipped with sprinklers. For this reason, the device of the present invention can be produced in a bright color for ease of visual identification. If desired, a variety of different colors can be used to identify different types of sprinkler heads.

The device of the present invention can be made of any suitable thermoplastic material. Suitable materials include, but are not limited to: polyoxymethylene plastic, nylon, lexan, abs, polystyrene, or any other suitable thermoplastic material.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A sprinkler nozzle tool, comprising a curved elongate handle portion having a first end and a second end, terminating at its first end in a bifurcated wedge portion terminating in a pair of spaced apart essentially parallel tines for engagement with a sprinkler nozzle; and
wherein the tapered tines are positioned at essentially a right angle to the axis of the shaft of the elongate handle portion and are buttressed by a triangular support portion; and
wherein each tapered tine begins at the base of the triangular support portion and tapers extends for a distance sufficient to effectively hold a sprinkler nozzle; and
wherein the space between the tines is contoured to receive a sprinkler nozzle; and
wherein the shaft of the elongate handle portion is slightly curved to comfortably receive a human hand; and
further comprising a hole near the second end.

2. The sprinkler nozzle tool of claim 1 wherein the tool is comprised of polyoxymethylene plastic, nylon, lexan, abs, polystyrene, or any other suitable thermoplastic material.

3. The sprinkler nozzle tool of claim 1 wherein the width of the elongate handle portion is approximately 1 inch to about 1.2 inches.

4. The sprinkler nozzle tool of claim 1 wherein the length of the entire device is approximately 5 inches and the thickness of the device is about 0.125 to about 0.15 inch.

5. The sprinkler nozzle tool of claim 1 wherein the space between the tines at their termini is about 0.63 inch.

6. The sprinkler nozzle tool of claim 1 wherein the curved elongate handle portion terminates at its second end in a flattened rounded portion having a hole for receiving a carabineer, keychain or other holding device.

7. The sprinkler nozzle tool of claim 6 wherein the hole is about 0.25 inch to about 0.4 inch in diameter.

8. The sprinkler nozzle tool of claim 1 wherein the tool is produced in a bright color for ease of visual identification.
